(19) United States
(12) Patent Application Publication
(10) Pub. No.: US 2020/0168169 A1
(43) Pub. Date: May 28, 2020

(54) DISPLAY SYSTEM FOR VEHICLE AND DISPLAY DEVICE FOR VEHICLE

(71) Applicant: Sharp Kabushiki Kaisha, Osaka (JP)

(72) Inventor: Kazuhiko YODA, Sakai City (JP)

(21) Appl. No.: 16/689,222

(22) Filed: Nov. 20, 2019

Related U.S. Application Data
(60) Provisional application No. 62/772,184, filed on Nov. 28, 2018.

(51) Int. Cl. G09G 3/36; G02F 1/1335; G02F 1/133; B60R 1/00

(52) U.S. Cl. CPC G09G 3/3648; G02F 1/133603; G02F 1/13318; B60R 2300/802; G09G 2320/0626; B60R 2300/105; B60R 2300/20; B60R 1/002

(57) ABSTRACT

A display system 1 for a vehicle includes an on-vehicle display device 10, and an image signal output circuit 22 that outputs an image signal indicating an image obtained by picking up an image of a scene behind the vehicle with use of at least a first camera 211. The on-vehicle display device 10 includes a first display 11a that includes a liquid crystal panel and a plurality of light sources provided on a back surface of the liquid crystal panel. The first display 11a displays an image based on an image signal output from the image signal output circuit 22. Further, the on-vehicle display device 10 includes an illuminance detection circuit 12 that detects an illuminance outside the vehicle, and a turn-on control circuit 12 that controls turn-on of the light sources in the first display 11a based on the detection result of the illuminance detection circuit13.

### TECHNICAL FIELD

The present invention relates to a display system for a vehicle and a display device for a vehicle.

### BACKGROUND ART

In recent years, an on-vehicle display device (display device for a vehicle) has been developed in which an electronic inner rear-view mirror that reflects a scene behind and on the rearward sides of the vehicle is mounted. Such an on-vehicle display device is disclosed in, for example, JP-A-2016-166010, JP-B-6349558, and the like.

The on-vehicle display device disclosed in JP-A-2016-166010 includes a display section in which a display is arranged on the back surface of a half mirror. In this on-vehicle display device, the half mirror and the display are switched from one to the other according to the brightness in the inside of the vehicle. When it is switched to the display, images of scenes behind and on the rearward sides of the vehicle picked up by cameras mounted on the vehicle are displayed on the display. This configuration prevents the visibility of the scenes behind and on the rearward sides of the vehicle displayed on the on-vehicle display device from decreasing when a vehicle indoor light is turned on.

The visibility of an image displayed on the on-vehicle display device is decreased not only by the turn-on of the vehicle indoor light, but also by the ambient brightness outside the vehicle. The human eye has, as its property, a better vision in dark environments, rather than bright environments. Therefore, in a case where an image is displayed on the on-vehicle display device in bright environments during daytime or the like, and in a case where the same image with the same luminance is displayed in dark environments during nighttime or the like, the visibility in the dark environments is higher than the visibility in the bright environments. On the other hand, in dark environments during nighttime or the like, the visibility of an image on the on-vehicle display device tends to decrease due to light from a headlight of a subsequent vehicle traveling behind.

### SUMMARY OF INVENTION

A display system for a vehicle in one embodiment of the invention disclosed herein includes: an illuminance detection circuit mounted on the vehicle, for detecting an illuminance around the vehicle; an image signal output circuit mounted on the vehicle, the image signal output circuit including at least a first camera for picking up an image of a scene behind the vehicle while the vehicle is traveling, and outputting an image signal that indicates an image picked up by the first camera; a display circuit that includes a first display that includes a liquid crystal panel and a plurality of light sources provided on a back surface of the liquid crystal panel, the first display displaying an image based on the image signal; and a turn-on control circuit that controls turn-on of the light sources based on a detection result of the illuminance detection circuit.

With the above-described configuration, it is not likely that the visibility on the on-vehicle display device (display device for a vehicle) would decrease depending on the ambient brightness around the vehicle.

### BRIEF DESCRIPTION OF DRAWINGS

FIG. 1 is a block diagram showing a schematic configuration of a display system for a vehicle in Embodiment 1.

FIG. 2A is a schematic diagram for explaining the positions of a first camera and a second camera shown in FIG. 1.

FIG. 2B is a schematic diagram for explaining horizontal photography angles of the first camera and the second camera shown in FIG. 2A.

FIG. 3 is a block diagram illustrating a schematic configuration of an on-vehicle display device shown in FIG. 1.

FIG. 4 is a cross-sectional view illustrating a schematic configuration of a liquid crystal panel shown in FIG. 3.

FIG. 5 shows an equivalent circuit of one pixel on an active matrix substrate shown in FIG. 4.

FIG. 6 is a block diagram showing a schematic configuration of a backlight and a backlight control unit shown in FIG. 3.

FIG. 7 is an equivalent circuit diagram illustrating a configuration of a constant current driving circuit of an LED driving circuit shown in FIG. 6.

FIG. 8 is a graph illustrating duty ratios corresponding to a first mode and a second mode that depend on the brightness levels in Embodiment 1.

FIG. 9 is a block diagram showing a schematic configuration of an on-vehicle display device in Embodiment 2.

FIG. 10 is a block diagram showing a schematic configuration of an on-vehicle display device in Embodiment 3.

### MODE FOR CARRYING OUT THE INVENTION

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, dimension ratios of constituent members shown in the drawings do not necessarily indicate actual dimension ratios.

### Embodiment 1

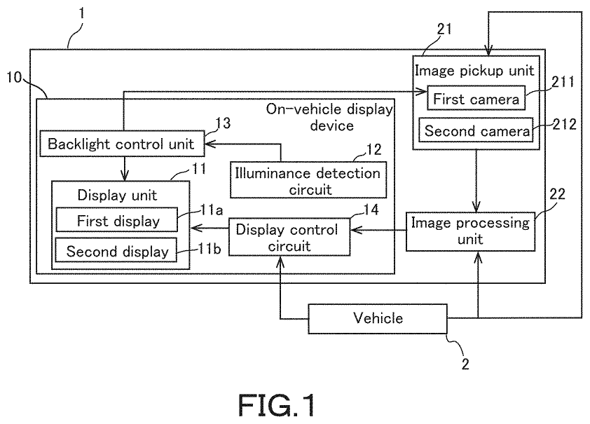

FIG. 1 is a block diagram showing a schematic configuration of a display system for a vehicle in the present embodiment. The display system 1 for a vehicle shown in FIG. 1 is mounted on an automatic automobile (not illustrated), and is electrically connected with a vehicle control system 2 mounted on the automatic automobile.

The vehicle control system 2 includes various types of electronic control units (ECU) such as an engine control unit, a power steering control unit, and a transmission control unit, and electronically controls respective mechanisms for driving the automatic automobile.

The display system 1 for a vehicle, As shown in FIG. 1, includes an on-vehicle display device (display device for a vehicle) 10, an image pickup unit 21, and an image processing circuit 22; these members operate when the vehicle control system 2 is being driven.

The on-vehicle display device 10 includes a display section 11, an illuminance detection circuit 12, a backlight control unit 13, and a display control circuit 14.

The display section 11 includes a first display 11a and a second display 11b. In this example, the first display 11a is provided, for example, on an inner side of the windshield (not illustrated) so that the display surface is arranged on the driver side. In other words, the first display 11a is provided at a position similar to the position of a common inner rear-view mirror. In this example, the second display 11b is provided, for example, on an instrument panel. Details about the first display 11a and the second display 11b are described below; these displays are liquid crystal displays that include a backlight.

The first display 11a and the second display 11b display images picked up by the image pickup unit 21 that is described below, and picked-up images displayed thereon are different. The first display 11a in this example is a display that functions as a common inner rear-view mirror, for displaying an image of a scene behind the vehicle that is seen through the rear window of the vehicle. The second display 11b in this example has a function as a rear view monitor that is used, for example, when the vehicle is moved backwards, and a function for displaying an image of a navigation system or television broadcasting.

The illuminance detection circuit 12 detects an illuminance as the ambient brightness around the vehicle, and outputs the detection result.

The backlight control unit 13 is connected with the illuminance detection circuit 12, and is also connected with the first display 11a. The backlight control unit 13 is formed with, for example, a control circuit such as a microcomputer that includes a computer processing unit (CPU), a memory (including a read only memory (ROM) and a random access memory (RAM)), and a timer (none of these illustrated). The backlight control unit 13 controls the turn-on of the backlight of the first display 11a based on the detection result of the illuminance detection circuit 12. A specific method for the control of the turn-on of the backlight performed by the backlight control unit 13 is described below.

The display control circuit 14 causes an image based on image signals output from the image processing circuit 22 to be displayed on the first display 11a and the second display 11b.

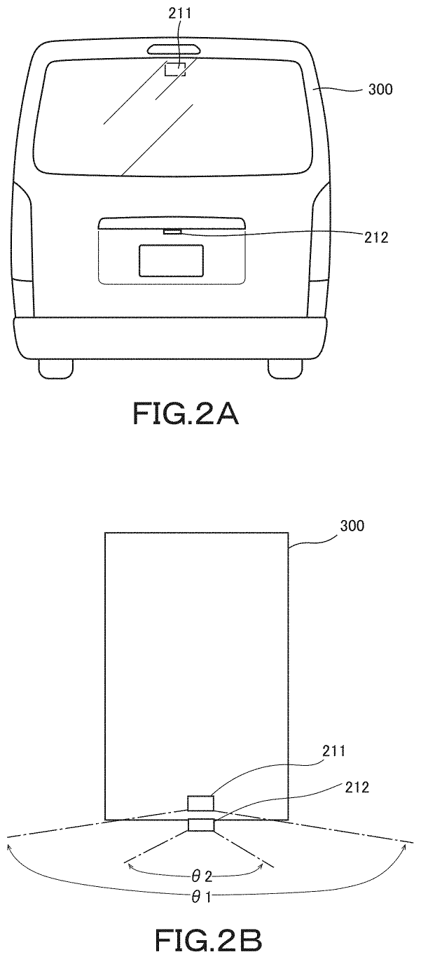

The image pickup unit 21 includes a first camera 211 and a second camera 212. As shown in FIG. 2A, the first camera 211 is mounted inside a rear window 310 in the rear part of the vehicle 300, and the second camera 212 is mounted outside the rear part of the vehicle 300, at a position lower than the position of the first camera 21a.

FIG. 2B schematically shows photographic angles of the first camera 211 and the second camera 212. As shown in FIG. 2B, the photographic angle θ1 in the horizontal direction of the first camera 211 is greater than the photographic angle θ2 in the horizontal direction of the second camera 212. The first camera 211 picks up an image of a scene behind the vehicle at least while the vehicle is traveling, and the second camera 212 picks up an image of a scene on a rearward lower side of the vehicle while the vehicle is traveling backwards. In other words, an image picked up by the second camera 212 is a rear view monitor image that contains an image of a parking space and the like while the vehicle is traveling backwards. The image picked up by the first camera 211 is an image obtained by picking up the scene viewed through the rear window, like a common inner rear-view mirror.

The image processing circuit 22 is connected with the image pickup unit 21, and is also connected with the on-vehicle display device 10. The image processing circuit 22 acquires image pickup signals output from the first camera 211, and image pickup signals output from the second camera 212, generates image signals according to color spaces of RGB corresponding to the first display 11a and the second display 11b based on the acquired image pickup signals, and outputs the image signals to the on-vehicle display device 10.

An image of the image signals based on the image pickup signals output from the first camera 211 is displayed on the first display 11a by the display control circuit 14, and an image of the image signals based on the image pickup signals output from the second camera 212 is displayed on the second display 11b by the display control circuit 14.

In the present embodiment, the first camera 211 adjust the exposure of the first camera 211 based on illuminance information output from the on-vehicle display device 10. Exemplary specific exposure adjustment for the first camera 211 is described below.

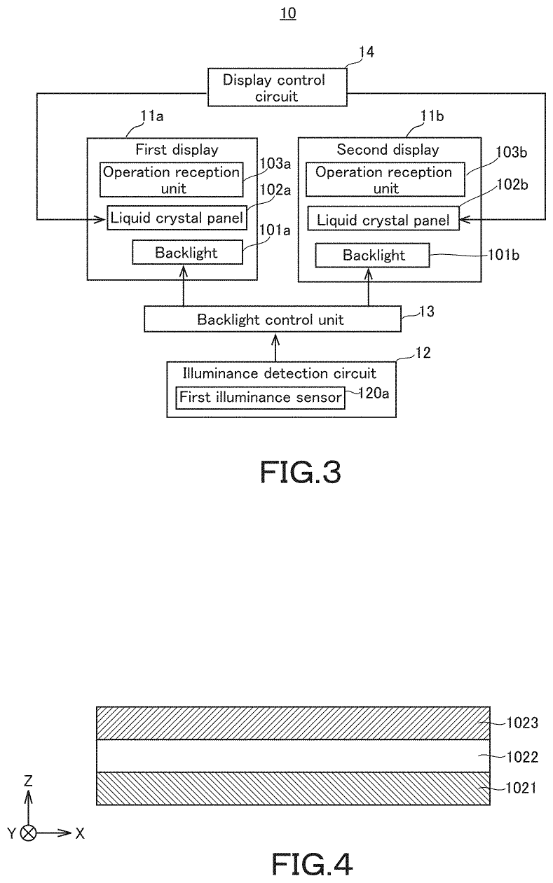

Here, the following description describes the configuration of the on-vehicle display device 10 specifically. FIG. 3 is a block diagram of the on-vehicle display device 10.

The illuminance detection circuit 12 includes a first illuminance sensor 120a.

The first illuminance sensor 120a is arranged on a back surface of the first display 11a, that is, on a surface of the first display 11a opposed to the windshield (not illustrated) of the vehicle.

The first illuminance sensor 120a is formed by using, for example, a photodiode, a phototransistor, or the like.

The first illuminance sensor 120a detects light from ahead of the vehicle, and outputs the detection result to the backlight control unit 13.

The backlight control unit 13 controls the turn-on of a backlight 101a of the first display 11a based on an operation received by an operation reception unit 103 of the first display 11a, and the detection result from the first illuminance sensor 120a. Further, the backlight control unit 13 outputs illuminance information based on the detection result from the first illuminance sensor 120a to the first camera 211. A specific exemplary the turn-on control of the backlight 101a is described below.

The first display 11a and the second display 11b include the backlights 101a and 101b, liquid crystal panels 102a, 102b, and operation reception units 103a, 103b, respectively.

The operation reception units 103a, 103b are formed with, for example, touch panels provided on the liquid crystal panels 102a, 102b, respectively, and may include operation buttons and the like. The operation reception units 103a, 103b receive operations for setting brightness (luminance) levels of displays of the liquid crystal panels 102a, 102b, and output operation signals indicating the set brightness levels to the backlight control unit 13.

Here, the following description describes the configurations of the liquid crystal panels 102a, 102b. FIG. 4 is a cross-sectional view showing a schematic configuration of the liquid crystal panel 102a. As the liquid crystal panel 102b has a configuration similar to that of the liquid crystal panel 102a, only the liquid crystal panel 102a is described herein.

As shown in FIG. 4, the liquid crystal panel 102a includes an active matrix substrate 1021, a liquid crystal layer 1022, and a counter substrate 1023. Though the illustration is omitted, each of the liquid crystal panels 102a, 102b includes a pair of polarizing plates between which the active matrix substrate 1021 and the counter substrate 1023 are interposed.

On the back surface sides of the liquid crystal panel 102a and the liquid crystal panel 102b, that is, on the surfaces which are opposite to the liquid crystal layer 12 of each active matrix substrate 1021, the backlights 101a, 101b are provided on the surface, respectively.

The active matrix substrate 1021 is connected with the display control circuit 14 through, for example, a flexible printed circuit (FPC) (not illustrated). Further, though the illustration is omitted, the active matrix substrate 1021 includes a plurality of gate lines, a plurality of source lines, a gate driver for scanning the gate lines, and a source driver for applying gray level voltages to the source lines. The gate driver (not illustrated) and the source driver (not illustrated) perform driving operations based on control signals supplied from the display control circuit 14 (see FIG. 3).

The gate driver includes shift registers (not illustrated) in correspondence to the gate lines, respectively. The shift registers in correspondence to the gate lines switch the gate lines sequentially into a selected state based on control signals such as a gate start pulse, a clock signal, and the like supplied from the display control circuit 14, so as to scan the gate lines.

The source driver applies gray level voltages of an image to be written in the pixels to the source lines, respectively, based on control signals such as data writing timing signals, data signals, and the like supplied from the display control circuit 14.

The active matrix substrate 1021 has a plurality of pixels that are areas defined by the gate lines and the source lines, each area being provided with a pixel electrode, thereby having a display area that is composed of all of the pixels.

The counter substrate 1023 includes color filters (not illustrated) of red (R), green (G), and blue (B). Each of the pixels in the active matrix substrate 1021 corresponds to any one of the colors of R, G, B of the color filter (not illustrated).

FIG. 5 is an equivalent circuit diagram of one pixel. The pixel PIX has a pixel switching element 1301 formed with, for example, a thin film transistor; a pixel electrode 1302; and a counter electrode 1303 provided on the counter substrate 1023. Regarding the pixel switching element 1301, the gate electrode thereof is connected with the gate line GL, the source electrode thereof is connected with the source line SL, and the drain electrode thereof is connected with the pixel electrode 1302. Between the pixel electrode 1302 and the counter electrode 1303, a liquid crystal capacitor CLC is formed. At a timing when the gate line GL of the pixel PIX is scanned, a gray level voltage applied to the source line SL of the pixel PIX is applied to the pixel PIX, and an image is displayed on the pixel PIX.

Here, the following description describes a configuration of the backlight 101a and a turn-on controlling operation of the backlight control unit 13.

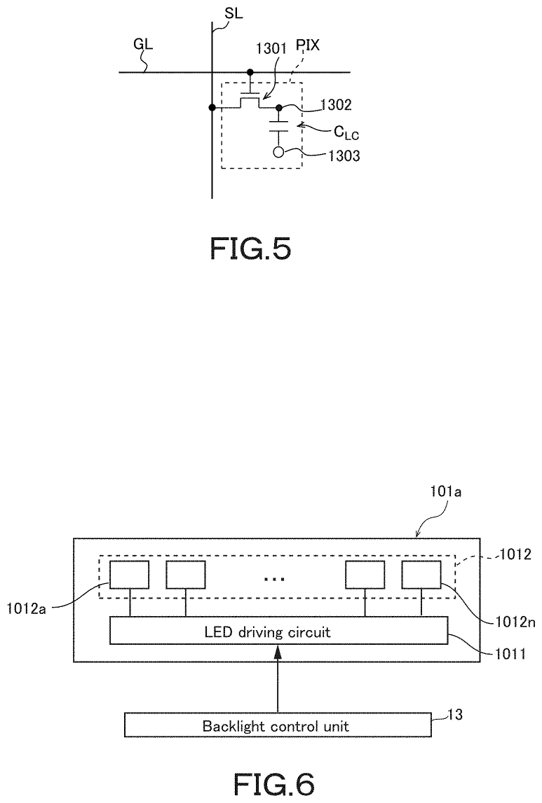

FIG. 6 is a block diagram illustrating the backlight 101a in the first display 11a and the backlight control unit 13 shown in FIG. 3. As shown in FIG. 6, the backlight 101a includes an LED driving circuit 1011, and N (N is a natural number of 2 or more) LED rows 1012 (1012a to 1012n). Each of the LED rows 1012 is connected with the LED driving circuit 1011.

In the backlight 101b in the second display 11b, the number of the LED rows is different from that in the backlight 101a, but the illustration of the same is omitted, as the backlight 101b has a configuration approximately similar to that of the backlight 101a.

To one LED row 1012, a plurality of white color LEDs are connected in series. The N LED rows 1012a to 1012n are connected in parallel.

The LED driving circuit 1011 is connected with the backlight control unit 13, and controls the turn-on of each LED row 1012 based on a pulse width modulation (PWM) signal from the backlight control unit 13. In this example, the LED driving circuit 1011 drives the LED rows 1012 by the static driving method of outputting a constant current based on the PWM signal. More specifically, in the LED driving circuit 1011, a limiting resistor (not illustrated) is connected to each LED row 1012, and a constant current driving circuit is connected to each limiting resistor. The LED driving circuit 1011 applies a voltage having a predetermined amplitude to the constant current driving circuit based on a resistance value of the limiting resistor and the PWM signal supplied from the backlight control unit 13. The constant current driving circuit outputs a constant current based on the applied voltage to the LED row 1012.

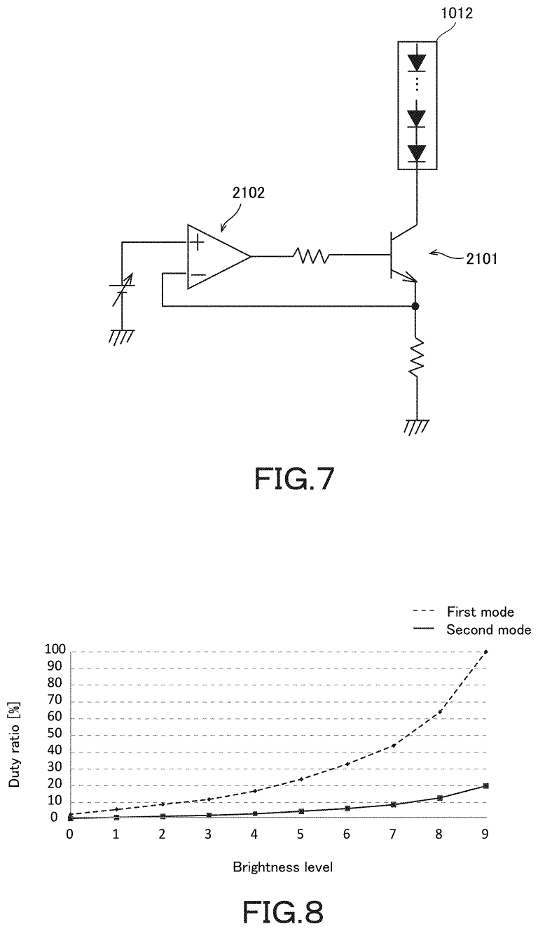

The above-described constant current driving circuit can be formed with a known circuit. FIG. 7 is an equivalent circuit diagram illustrating a circuit configuration of the constant current driving circuit. As shown in FIG. 7, the constant current driving circuit can be formed by using an npn transistor 2101 and an operational amplifier 2102. The collector of the npn transistor 2101 is connected with the LED row 1012, the emitter thereof is connected with the inverting input element (−) of the operational amplifier 2102, and the base thereof is connected with an output terminal of the operational amplifier 2102. To the non-inverting input element (+) of the operational amplifier 2102, a voltage set based on the PWM signal is applied.

The backlight control unit 13 adjusts the duty ratio of the PWM signal with respect to the LED driving circuit 1011 based on the brightness level indicated by the operation reception unit 103, and a detection result output at predetermined intervals by the first illuminance sensor 120a.

In other words, the backlight control unit 13 adjusts the duty ratio corresponding to a current brightness level, according to a detection result output at predetermined intervals from the first illuminance sensor 120a. More specifically, the backlight control unit 13 adjusts the duty ratio corresponding to the first mode when the illuminance detected by the first illuminance sensor 120a is above a first threshold value (for example, 400 lx), and adjusts the duty ratio corresponding to the second mode when the illuminance is below a second threshold value (for example, 300 lx).

FIG. 8 is a graph illustrating duty ratios of the PWM signal with respect to the backlight 101a in the first mode and in the second mode regarding brightness levels. In FIG. 8, the curve indicated by a broken line corresponds to the first mode, and the curve indicated by a solid line corresponds to the second mode. The horizontal axis in FIG. 8 indicates brightness levels of the first display 11a that are selectable by a user's operation, and in this example, 10 brightness levels of 0 to 9 are provided. Further, the vertical axis in FIG. 8 indicates duty ratios (%) of the PWM signal with respect to the backlight 101a in correspondence to the brightness levels, representing the luminance of the backlight 101a. For example, in a case where the duty ratio is 100%, the LED rows 1012 of the backlight 101a are continuously turned on, and in a case where the duty ratio is 0%, the LED rows 1012 are turned off. Further, in a case where the duty ratio is 50%, the turn-on and the turn-off of the LED rows 1012 are repeated alternately for the same periods.

As shown in FIG. 8, the duty ratio of the PWM signal corresponding to each brightness level in the first mode is greater than the duty ratio of the PWM signal corresponding to each brightness level in the second mode. Therefore, in a case where the backlight 101a is turned on in the first mode, the backlight 101a has a greater luminance than that in a case where the backlight 101a is turned on in the second mode.

In the present embodiment, as to the first mode and the second mode, duty ratios at the ten-grade brightness levels that can be selected by a user's operation are preliminarily stored in the backlight control unit 13. The backlight control unit 13 selects a duty ratio in the first mode or the second mode corresponding to a currently set brightness level, based on the detection result of the first illuminance sensor 120a, and outputs the PWM signal of the selected duty ratio to the LED driving circuit 1011 of the backlight 101a.

It should be noted that duty ratios at the brightness levels corresponding to the first mode and those corresponding to the second mode may be calculated by using respective predetermined arithmetic formulae corresponding to the first mode and the second mode in the backlight control unit 13.

Further, based on the detection result of the first illuminance sensor 120a, the backlight control unit 13 outputs either the first mode or the second mode as illuminance information to the first camera 211 (see FIG. 1). The first camera 211 adjusts the shutter speed and the aperture value so as to achieve the exposure corresponding to the mode indicated by illuminance information. In the present embodiment, in a case of the second mode, the first camera 211 adjusts the shutter speed and the aperture value so as to achieve greater exposure than that in the first mode. In other words, the first camera 211 adjusts exposure in such a manner that a picked-up image is brighter as it is darker outside the vehicle.

The first mode is a mode for controlling the turn-on of the backlight 101a in a state where it is bright around the vehicle, such as during daytime, and the second mode is a mode for controlling the turn-on of the backlight 101a in a state where it is dark around the vehicle, such as during nighttime. Owing to the property of the human eye, the visibility of a displayed image tends to decrease when the display has a higher luminance in a dark place. In the present embodiment, in a dark state, such as during nighttime, the first camera 211 has greater exposure than that in the first mode, and the turn-on control in the second mode is performed by the backlight 101a. This allows a brighter picked-up image to be displayed on the first display 11a, and allows the backlight 101a of the first display 11a to have a lower luminance than that in the first mode. As a result, this allows the displayed image on the first display 11a to have improved visibility, as compared with a case where the luminance of the backlight 101a of the first display 11a is not adjusted according to the ambient brightness (illuminance).

Incidentally, though the backlight 101a of the first display 11a is adjusted according to the detection result of the first illuminance sensor 120a in the above-described example, the backlight 101b of the second display 11b may be adjusted according to the detection result of the first illuminance sensor 120a, in the same manner as that for the first display 11a. In this case, duty ratios at the brightness levels corresponding to the first mode and those corresponding to the second mode, as to each brightness level that can be set for the second display 11b, may be stored in the backlight control unit 13 for the backlight 101b of the second display 11b. Alternatively, in the backlight control unit 13, the duty ratio in correspondence to the brightness level may be calculated, by using respective predetermined arithmetic formulae corresponding to the first mode and the second mode for the backlight 101b.

### Embodiment 2

Embodiment 1 described above is described with reference to an example in which the turn-on control of the backlight 101a of the first display 11a is performed based on the brightness (illuminance) ahead the vehicle that is detected by the first illuminance sensor 120a. In the present embodiment, in a dark state, such as during nighttime or the like, the visibility on the first display 11a is prevented from decreasing due to light from behind the vehicle, such as light of the headlight of a subsequent vehicle traveling behind.

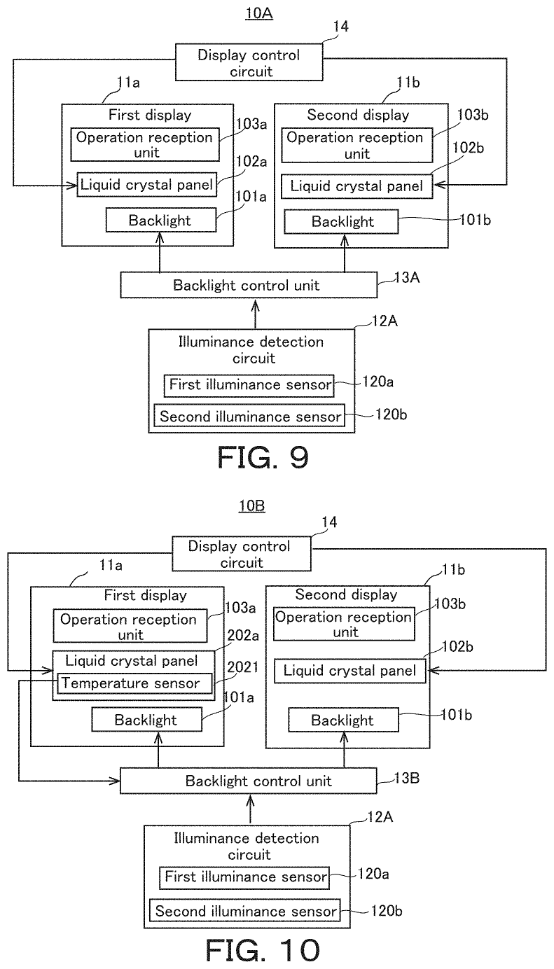

FIG. 9 is a block diagram of an on-vehicle display device 10A in the present embodiment. In FIG. 9, the same constituent members as those in Embodiment 1 are denoted by the same reference symbols as those in Embodiment 1. The following description principally describes constituent members different from those in Embodiment 1.

As shown in FIG. 9, the on-vehicle display device 10A includes a backlight control unit 13A and an illuminance detection circuit 12A.

The illuminance detection circuit 12A includes a first illuminance sensor 120a and a second illuminance sensor 120b. The second illuminance sensor 120b is formed with a photodiode, a phototransistor, or the like, as is the case with the first illuminance sensor 120a. The second illuminance sensor 120b is arranged on a display surface of the first display 11a, and outputs a detection result to the backlight control unit 13A.

As is the case with the backlight control unit 13, the backlight control unit 13A determines either the first mode or the second mode based on the detection result of the first illuminance sensor 120a. In a case of the first mode, as is the case with Embodiment 1, the backlight control unit 13A outputs a PWM signal of a duty ratio of a current brightness level corresponding to the first mode, to the backlight 101a of the first display 11a.

On the other hand, in a case of the second mode, the backlight control unit 13A corrects a duty ratio of a current brightness level corresponding to the second mode, based on the detection result of the second illuminance sensor 120b. More specifically, in a case where, for example, the detection result of the second illuminance sensor 120b and the detection result of the first illuminance sensor 120a have a difference therebetween greater than a predetermined threshold value, the correcting operation is performed so as to make the current duty ratio greater. The backlight control unit 13A outputs a PWM signal of the corrected duty ratio to the LED driving circuit 1011 of the backlight 101a (see FIG. 6).

In the present embodiment, whether it is brighter behind the vehicle than ahead the vehicle or not can be detected, from the detection result of the second illuminance sensor 120b and the detection result of the first illuminance sensor 120a. Therefore, in the second mode, in a case where it is brighter behind the vehicle than ahead the vehicle, the luminance of the backlight 101a corresponding to the second mode at the current brightness level may be increased, whereby the visibility on the first display 11a can be prevented from decreasing due to light from behind the vehicle.

### Embodiment 3

The above-described embodiments are described with reference to examples in which the luminance of the backlight 101a based on the brightness (illuminance) outside the vehicle. The present embodiment is described with reference to an example in which the luminance of the backlight 101a is adjusted not only according to the brightness (illuminance) outside the vehicle, but also according to the temperature inside the first display 11a.

FIG. 10 is a block diagram of an on-vehicle display device according to the present embodiment. In FIG. 10, the same constituent members as those in Embodiment 2 are denoted by the same reference symbols as those in Embodiment 2. The following description principally describes constituent members different from those in Embodiment 2.

An on-vehicle display device 10B is different from the on-vehicle display device in Embodiment 2 in the point that the first display 11a includes a liquid crystal panel 202a having a temperature sensor 2021, and a backlight control unit 13B.

The temperature sensor 2021 is connected with the backlight control unit 13B. The temperature sensor 2021 is formed with, for example, a thermistor circuit. The temperature sensor 2021 is provided in the liquid crystal panel 202a, on a back surface side of the active matrix substrate 1021 (see FIG. 4). The temperature sensor 2021 detects temperature in the vicinities of the backlight 101a at constant intervals (for example, 50 ms), and outputs a signal indicating the detection result to the backlight control unit 13B. The detection result of the temperature sensor 2021, which is output to the backlight control unit 13B, may be, for example, a moving average value of the temperature detected at every 50 ms.

The backlight control unit 13B is formed with, for example, a control circuit such as a microcomputer, as is the case with the backlight control unit 13, 13A. Every time when a predetermined unit time (for example, 10 seconds) timed by a timer (not illustrated) elapses, the backlight control unit 13B adjusts the duty ratio of the PWM signal with respect to the LED driving circuit 1011 (see FIG. 6) in the backlight 101a, based on the temperature detected by the temperature sensor 2021, and the detection result of the first illuminance sensor 120a.

In the present embodiment, the backlight control unit 13B preliminarily stores duty ratios (DT) corresponding to temperature levels in the liquid crystal panel 202a, and duty ratios (DB) respectively corresponding to ten-grade brightness (luminance) levels. The backlight control unit 13B calculates a duty ratio (DLx) corresponding to the currently set brightness level, based on detection results (illuminances) of the first illuminance sensor 120a and the second illuminance sensor 120b, by using the following formula (1):

DLx=DB×Gf×Gb Formula (1)
DB: duty ratio corresponding to brightness level
Gf: gain value based on detection result of the first illuminance sensor 120a
Gb: gain value based on detection result of the second illuminance sensor 120b

The above-described gain value Gf varies with the illuminance detected by the first illuminance sensor 120a, and for example, takes a value satisfying 0.2≤Gf≤1.0. The gain value Gf increases like a quadratic function so as to approach 1.0 as the illuminance detected by the first illuminance sensor 120a increases.

The above-described gain value Gb varies with the illuminance detected by the second illuminance sensor 120b, and for example, takes a value satisfying 1.0≤Gb≤2.0. In the present embodiment, when the illuminance detected by the second illuminance sensor 120b is greater by a predetermined value than the illuminance detected by the first illuminance sensor 120b, the gain value Gb is set to 2.0; and in the other case, the gain value Gb is set to 1.0.

In a case where the headlight of a subsequent vehicle traveling behind is turned on in a dark state such as nighttime, the illuminance detected by the second illuminance sensor 120b is greater than the illuminance detected by the first illuminance sensor 120a. In this case, it is highly possible that it is brighter behind the vehicle than ahead the vehicle, and the visibility on the first display 11a tends to decrease due to light from behind the vehicle. In the present embodiment, in a case where a difference between the illuminance detected by the second illuminance sensor 120b and the illuminance detected by the first illuminance sensor 120a is equal to or greater than a predetermined value, it is assumed that it is brighter behind the vehicle than ahead the vehicle, and the gain value Gb is set to the maximum (2.0 in the present example). Consequently, the duty ratio DLx is corrected to a greater value than the duty ratio DB corresponding to the current brightness level, which causes the backlight 101a to have a higher luminance as compared with a case where the duty ratio is not corrected.

On the other hand, in a case where the difference between the illuminance detected by the second illuminance sensor 120b and the illuminance detected by the first illuminance sensor 120a is smaller than a predetermined value, it is assumed that it is brighter behind the vehicle than ahead the vehicle, and the gain value Gb is set to the minimum (1.0 in the present example). In other words, in this case, the duty ratio DLx is calculated based on the duty ratio DB corresponding to the current brightness level, and the gain value Gb corresponding to the illuminance detected by the first illuminance sensor 120a.

The backlight control unit 13B selects the smaller one out of the duty ratio DT corresponding to the detected temperature and the duty ratio DLx calculated from the detected illuminance, and outputs a PWM signal of the selected duty ratio to the LED driving circuit 1011 of the backlight 101a. This configuration makes it possible to allow the first display 11a to display an image at a luminance corresponding to illuminances on the front side and the rear side of the vehicle, while preventing the liquid crystal panel 202a from having display defects due to a temperature rise in the liquid crystal panel 202a in the first display 11a.

The foregoing description describes examples of the display system for a vehicle, and the on-vehicle display device according to the present invention; the display system for a vehicle and the on-vehicle display device, however, are not limited to the configurations of the above-described embodiments, and may have a variety of modification configurations.

(1) Embodiment 3 described above is described with reference to an example in which the smaller duty ratio is selected out of the duty ratio DT corresponding to the detected temperature and the duty ratio DLx calculated from the detected illuminance, but the duty ratio may be determined in the following manner.

For example, the configuration may be as follows: in a case where the temperature detected by the temperature sensor 2021 is at or above a predetermined temperature, a duty ratio DT corresponding to the detected temperature is selected, and in the other cases, a duty ratio DLx corresponding to the detected illuminance is selected. This configuration makes it possible to allow the first display 11a to display an image at brightness (luminance) corresponding to illuminances on the front side and the rear side of the vehicle, while preventing display defects due to a temperature rise in the liquid crystal panel 202a in the first display 11a.

(2) Embodiment 3 described above is described with reference to an example in which the temperature sensor 2021 is provided only in the liquid crystal panel 202a in the first display 11a, but a temperature sensor may be provided in the liquid crystal panel 202b in the second display 11b. In this case, the backlight control unit 13B may adjust the turn-on of the backlight 101b of the second display 11b based on the detection results of the temperature sensor in the second display 11b and the first illuminance sensor 120a.

More specifically, the backlight control unit 13B stores the duty ratios of the PWM signals for the backlight 101b as to each temperature, and as is the case with Embodiment 1, preliminarily stores duty ratios at the respective brightness levels corresponding to the first mode and the second mode. As the second display 11b is provided at a position lower than that of the first display 11a, it is more unlikely that the second display 11b would be affected by light from behind the vehicle, as compared with the first display 11a. In this example, therefore, as is the case with Embodiment 1, the duty ratio based on the illuminance detected by the first illuminance sensor 120a is stored in the backlight control unit 13B.

The backlight control unit 13B selects the smaller duty ratio out of the duty ratio corresponding to the temperature detected by the temperature sensor in the liquid crystal panel 202b and the duty ratio of the current brightness level corresponding to the first mode or the second mode. The backlight control unit 13B outputs the PWM signal of the selected duty ratio to the LED driving circuit 1011 in the backlight 101b. This configuration makes it possible to allow the second display 11b to display an image at brightness (luminance) corresponding to the illuminance, while decreasing display defects due to a temperature rise in the liquid crystal panel 202b in the second display 11b.

Incidentally, in this example as well, as is the case with Embodiment 2, the turn-on control of the backlight 101b in the second display 11b may be performed according to the detection result of the second illuminance sensor 120b.

(3) The above-described embodiments are described with reference to examples in which the on-vehicle display device is provided with the first display 11a and the second display 11b, but any configuration is applicable as long as the on-vehicle display device is provided with at least the first display. In other words, any configuration may be applicable as long as at least one display for displaying an image of the scene behind the vehicle during traveling. In addition, examples in which the first display 11a is provided on an inner side of the windshield so that the display surface is arranged on a driver side are described, but the position of the first display 11a is not limited to this. In a case where the second display 11b is not provided, the first display 11a may be arranged in an instrument panel, or may be arranged above the instrument panel.

(4) The above-described embodiments are described with reference to examples in which the first display 11a has a function as an inner rear-view mirror, but the first display 11a may have a function as a side mirror. In other words, an image obtained by picking up a scene on the rearward side of the vehicle may be displayed on the first display 11a so that an image similar to a scene reflected on a common side mirror should be displayed thereon. Further, an image of a scene behind the vehicle, which is similar to a scene reflected on a common inner rear-view mirror, and an image similar to a scene on the rearward side of the vehicle, which is similar to a scene reflected on a common side mirror, may be switched from one to the other and displayed on the first display 11a.

(5) Further, in the above-described embodiments, in the display system 1 for a vehicle, the number of cameras provided in the image pickup unit 21 is not limited two, i.e., the first camera 211 and the second camera 212; any configuration is applicable as long as at least one camera for displaying an image on the first display 11a is provided. In other words, in the above-described example, the image pickup unit 21 may include at least the first camera 211.

(6) The above-described embodiments are described with reference to examples in which an image picked by the first camera 211 is displayed on the first display 11a, but, for example, another image may be superposed on the image picked up by the first camera 211 so as to be displayed.

The above-described display system for a vehicle, and the above-described display device for a vehicle (on-vehicle display device) can be described as follows.

A display system for a vehicle according to the first configuration includes an illuminance detection circuit mounted on the vehicle, for detecting an illuminance around the vehicle; an image signal output circuit mounted on the vehicle, the image signal output circuit including at least a first camera for picking up an image of a scene behind the vehicle while the vehicle is traveling, and outputting an image signal that indicates an image picked up by the first camera; a display circuit that includes a first display that includes a liquid crystal panel and a plurality of light sources provided on a back surface of the liquid crystal panel, the first display displaying an image based on the image signal; and a turn-on control circuit that controls turn-on of the light sources based on a detection result of the illuminance detection circuit.

According to the first configuration, in the display system for a vehicle, at least an image signal indicating an image obtained by picking up a scene behind the vehicle with the first camera while the vehicle is traveling is output from the image signal output circuit, and the first display displays an image based on the image signal. The first display includes a liquid crystal panel and a plurality of light sources arranged on the back surface of the liquid crystal panel. In the display system for a vehicle, the turn-on control circuit controls the turn-on of the light sources based on the illuminance detected by the illuminance detection circuit. This makes it unlikely that the visibility of an image displayed on the display would decrease depending on the illuminance around the vehicle.

The first configuration may be further characterized in that the first display whose display surface is arranged on a side of a driver of the vehicle is provided on an inner side of a windshield of the vehicle (the second configuration).

According to the second configuration, the first display can perform a function similar to that of a common inner rear-view mirror.

The first or second configuration may be further characterized in that the turn-on control circuit adjusts a duty ratio of a driving signal for controlling turn-on of the light sources by pulse width modulation (PWM) control based on a detection result of the illuminance detection circuit (the third configuration).

With the third configuration, the duty ratio is adjusted according to the illuminance around the vehicle, whereby an image can be displayed with luminance of the light sources corresponding to the illuminance around the vehicle.

The third configuration may be further characterized in that the illuminance detection circuit includes a first illuminance sensor for detecting an illuminance ahead the vehicle, the turn-on control circuit selects a first mode in a case where an illuminance detected by the first illuminance sensor is at or above a first threshold value, selects a second mode in a case where the illuminance detected by the first illuminance sensor is at or below a second threshold value that is lower than the first threshold value, and controls the light sources with a duty ratio of the driving signal corresponding to a mode selected by the turn-on control circuit, and the duty ratio of the driving signal corresponding to the first mode is greater than that corresponding to the second mode (the fourth configuration).

According to the fourth configuration, the light sources are turned on according to a driving signal of a duty ratio corresponding to a first mode or a second mode selected according to a result of detection by the first illuminance sensor. The first mode indicates a state in which it is brighter ahead the vehicle, as compared with the second mode. As the duty ratio corresponding to the first mode is greater than the duty ratio corresponding to the second mode, the luminance of the light sources is higher in the first mode. In other words, as it is brighter ahead the vehicle, the luminance of the first display is higher, and as it is darker ahead the vehicle, the luminance of the first display is lower. Therefore, the visibility on the first display can be prevented from decreasing due to light from ahead the vehicle.

The fourth configuration may be further characterized in that the illuminance detection circuit further includes a second illuminance sensor for detecting an illuminance behind the vehicle; and in a case where the turn-on control circuit selects the second mode, and in a case where the illuminance detected by the second illuminance sensor is greater than the illuminance detected by the first illuminance sensor by a predetermined value, the turn-on control circuit corrects the duty ratio of the driving signal so that the duty ratio of the driving signal corresponding to the second mode becomes further greater (the fifth configuration).

In the second mode, in a case where the illuminance behind the vehicle, detected by the second illuminance sensor, is greater than the illuminance ahead the vehicle, detected by the first illuminance sensor, by a predetermined value or more, it is in a state where it is brighter behind the vehicle than ahead the vehicle. In other words, in this case, there is a possibility that the headlight of a subsequent vehicle traveling behind is turned on during nighttime or the like. According to the fifth configuration, in such a state, the duty ratio is corrected so that the duty ratio of a driving signal corresponding to the second mode is increased further. Consequently, the light sources have a higher luminance as compared with a case where the duty ratio is not corrected, whereby it is unlikely that the visibility on the first display would decrease due to the headlight of a subsequent vehicle traveling behind.

Any one of the first to fifth configurations may be further characterized in that the first display includes a temperature sensor for detecting a temperature inside the first display; and the turn-on control circuit adjusts the duty ratio of the driving signal, according to the temperature detected by the temperature sensor, and the illuminance detected by the illuminance detection circuit (the sixth configuration).

With the sixth configuration, the duty ratio of the driving signal is adjusted according to not only the illuminance around the vehicle but also the internal temperature in the first display. This makes it possible to reduce a decrease in the visibility on the first display, while protecting the liquid crystal panel of the first display.

The sixth configuration may be further characterized in that the turn-on control circuit uses, in turn-on control with respect to the light sources, a duty ratio having the smaller value out of the duty ratio of the driving signal corresponding to the temperature detected by the temperature sensor and the duty ratio of the driving signal based on the detection result of the illuminance detection circuit (the seventh configuration).

With the seventh configuration, the smaller the duty ratio of the driving signal, the smaller the luminance of the light sources and it is possible to prevent the temperature rise in the first display caused by the turn-on of the light sources, thereby making it possible to suppress display defects of the liquid crystal panel caused by temperature changes in the first display.

The sixth configuration may be further characterized in that, in a case where the temperature detected by the temperature sensor is at or above a predetermined temperature, the turn-on control circuit uses a duty ratio of the driving signal corresponding to the temperature, in turn-on control with respect to the light sources (the eighth configuration).

With the eighth configuration, display defects of the liquid crystal panel caused by temperature changes inside the first display can be decreased.

Any one of the first to eighth configurations may be further characterized in that the image signal output circuit adjusts at least exposure of the first camera based on an illuminance detected by the illuminance detection circuit (the ninth configuration).

According to the ninth configuration, at least the first camera picks up an image of a scene behind the vehicle at an exposure corresponding to the illuminance around the vehicle. This makes it possible to further enhance the visibility of an image displayed on the first display.

Any one of the first to ninth configurations may be further characterized in that the image signal output circuit further includes a second camera, the first camera picks up an image of a scene behind the vehicle when the vehicle is driven, the second camera picks up an image of a scene behind the vehicle at an angle of view different from that of the first camera, when the vehicle is driven so as to travel backwards, the display circuit further includes a second display that includes a liquid crystal panel, and a plurality of light sources provided on a back surface of the liquid crystal panel, and displays an image based on an image signal obtained by image pickup by the second camera, and the turn-on control circuit controls turn-on of the light sources in the second display, based on the detection result of the illuminance detection circuit (the tenth configuration).

With the tenth configuration, an image obtained by picking up an image of a scene behind the vehicle at an angle of view different from that of the first camera can be displayed on the second display while the vehicle is traveling backwards. Further, the turn-on of the light sources of the second display is controlled according to the illuminance around the vehicle. This makes it unlikely that a driver would have difficulty in viewing images displayed on the first display and the second display depending on illuminance around the vehicle.

A display device for a vehicle includes the illuminance detection circuit, the display circuit, and the turn-on control circuit according to any one of claims 1 to 10 (the eleventh configuration).

With the eleventh configuration, an image obtained by picking up a scene behind the vehicle is displayed on the first display, and the turn-on of the light sources in the first display is controlled according to the illuminance around the vehicle. This makes it unlikely that the visibility on the first display would decrease due to brightness around the vehicle.

What is claimed is:

1. A display system for a vehicle, the display system comprising:
an illuminance detection circuit mounted on the vehicle, for detecting an illuminance around the vehicle;
an image signal output circuit mounted on the vehicle, the image signal output circuit including at least a first camera for picking up an image of a scene behind the vehicle while the vehicle is traveling, and outputting an image signal that indicates an image picked up by the first camera;
a display circuit that includes a first display that includes a liquid crystal panel and a plurality of light sources provided on a back surface of the liquid crystal panel, the first display displaying an image based on the image signal; and
a turn-on control circuit that controls turn-on of the light sources based on a detection result of the illuminance detection circuit.

2. The display system for a vehicle according to claim 1,
wherein the first display whose display surface is arranged on a side of a driver of the vehicle is provided on an inner side of a windshield of the vehicle.

3. The display system for a vehicle according to claim 1,
wherein the turn-on control circuit adjusts a duty ratio of a driving signal for controlling turn-on of the light sources by pulse width modulation (PWM) control based on the detection result of the illuminance detection circuit.

4. The display system for a vehicle according to claim 3,
wherein the illuminance detection circuit includes a first illuminance sensor for detecting an illuminance ahead the vehicle,
the turn-on control circuit selects a first mode in a case where an illuminance detected by the first illuminance sensor is at or above a first threshold value, selects a second mode in a case where the illuminance detected by the first illuminance sensor is at or below a second threshold value that is lower than the first threshold value, and controls the light sources with a duty ratio of the driving signal corresponding to a mode selected by the turn-on control circuit, and
the duty ratio of the driving signal corresponding to the first mode is greater than that corresponding to the second mode.

5. The display system for a vehicle according to claim 4,
wherein the illuminance detection circuit further includes a second illuminance sensor for detecting an illuminance behind the vehicle, and
in a case where the turn-on control circuit selects the second mode, and in a case where the illuminance detected by the second illuminance sensor is greater than the illuminance detected by the first illuminance sensor by a predetermined value, the turn-on control circuit corrects the duty ratio of the driving signal so that the duty ratio of the driving signal corresponding to the second mode becomes further greater.

6. The display system for a vehicle according to claim 3,
wherein the first display includes a temperature sensor for detecting a temperature inside the first display, and
the turn-on control circuit adjusts the duty ratio of the driving signal, according to the temperature detected by the temperature sensor, and the illuminance detected by the illuminance detection circuit.

7. The display system for a vehicle according to claim 6,
wherein the turn-on control circuit uses, in turn-on control with respect to the light sources, a duty ratio having the smaller value out of the duty ratio of the driving signal corresponding to the temperature detected by the temperature sensor and the duty ratio of the driving signal based on the detection result of the illuminance detection circuit.

8. The display system for a vehicle according to claim 6,
wherein, in a case where the temperature detected by the temperature sensor is at or above a predetermined temperature, the turn-on control circuit uses a duty ratio of the driving signal corresponding to the temperature, in turn-on control with respect to the light sources.

9. The display system for a vehicle according to claim 1,
wherein the image signal output circuit adjusts at least exposure of the first camera based on an illuminance detected by the illuminance detection circuit.

10. The display system for a vehicle according to claim 1,
wherein the image signal output circuit further includes a second camera,
the first camera picks up an image of a scene behind the vehicle when the vehicle is driven,
the second camera picks up an image of a scene behind the vehicle at an angle of view different from that of the first camera, when the vehicle is driven so as to travel backwards,
the display circuit further includes a second display that includes a liquid crystal panel, and a plurality of light sources provided on a back surface of the liquid crystal panel, and displays an image based on an image signal obtained by image pickup by the second camera, and
the turn-on control circuit controls turn-on of the light sources in the second display, based on the detection result of the illuminance detection circuit.

11. A display device for a vehicle, the display device comprising:
the illuminance detection circuit, the display circuit, and the turn-on control circuit according to claim 1.
